(19) United States
(12) Patent Application Publication
(10) Pub. No.: US 2017/0185678 A1
(43) Pub. Date: Jun. 29, 2017

(54) CRAWLER SYSTEM AND METHOD

(71) Applicants: Le Holdings (Beijing) Co., Ltd., Beijing (CN); LE SHI INTERNET INFORMATION&TECHNOLOGY CORP., BEIJING, Beijing (CN)

(72) Inventor: Qifeng ZOU, Beijing (CN)

(21) Appl. No.: 15/242,430

(22) Filed: Aug. 19, 2016

Related U.S. Application Data
(63) Continuation of application No. PCT/CN2016/088543, filed on Jul. 5, 2016.

(30) Foreign Application Priority Data
Dec. 28, 2015 (CN) 2015110015506

(51) Int. Cl. G06F 17/30

(52) U.S. Cl. CPC G06F 17/30864; G06F 17/30887

(57) ABSTRACT

Disclosed are a crawler system and method. The crawler system includes: a web page analyzer, adapted to analyze a web page, acquire an IP address of the web page from a DNS server and generate a crawling task; a task module, adapted to store the crawling task into a task queue; and a crawler module, adapted to acquire the crawling task from the task queue, and crawl web page data.

### CROSS REFERENCE TO RELATED APPLICATIONS

This application is a continuation of International Application No. PCT/CN2016/088543, filed on Jul. 5, 2016, which is based upon and claims priority to Chinese Patent Application NO. 201511001550.6, titled “crawler system”, filed Dec. 28, 2015, the entire contents of which are incorporated herein by reference.

### TECHNICAL FIELD

The disclosure relates to the technical field of web page search, and in particular to a crawler method and an electronic equipment.

### BACKGROUND

Web crawler is a program for automatically extracting web pages, which downloads web pages for a search engine on the Internet (internet), and which is an important component of the search engine. The traditional crawler is used to acquire a Uniform Resource Locator (URL) on an initial web page starting from the URL of one or several initial web pages, and then start a crawler module to crawl the web pages. In the process of crawling the web pages, a new URL is continuously extracted from the current page and is putted into a queue, and analysis is continued. So repeatedly, the whole Internet is accessed until a stop condition of a system is met.

Since the crawler module crawls the web page data from the URL address, an IP address and an access port of the web page are needed to be acquired through the URL. In this process, an illegal URL address may cause long congestion of the crawler module and cause a crawling task to be stopped, thereby affecting the crawling efficiency of the whole system.

### SUMMARY

In view of the above, a crawler method and an electronic equipment which prevent DNS congestion are provided according to the disclosure, to solve the above-described issues.

In an aspect of the disclosure, a crawler method is provided, which includes: a web page analyzing step of analyzing a web page, acquiring an IP address of the web page from a DNS server, generating a crawling task, and storing the crawling task into a task queue; and a crawling step of acquiring the crawling task from the task queue, and crawling web page data.

In another aspect of the disclosure, there is provided an electronic equipment, includes: at least one processor, and a storage which is communicated by at least one processor. Wherein, the storage stores executable instruction by one processor. The instruction is set for executing the crawler method provided by the disclosure.

In another aspect of the disclosure, there is provided a non-transitory computer storage medium which storing computer executable instruction. The computer executable instruction is used for executing the crawler method provided by the disclosure.

One or more embodiments are illustrated by way of example, and not by limitation, in the figures of the accompanying drawings, wherein elements having the same reference numeral designations represent like elements throughout. The drawings are not to scale, unless otherwise disclosed.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an arrangement diagram of a crawler system in accordance with an embodiment.

FIG. 2 is a timing diagram of a crawler system in accordance with an embodiment.

FIG. 3 is a timing diagram of a web page analyzer in accordance with an embodiment.

FIG. 4 is a flow chart of a configuration unit of a crawler module in accordance with an embodiment.

FIG. 5 is a flow chart of a first scheduling unit of a crawler module in accordance with an embodiment.

FIG. 6 is a flow chart of a crawling unit of a crawler module in accordance with an embodiment.

FIG. 7 is a flow chart of receiving data in a crawling unit of a crawler module in accordance with an embodiment.

FIG. 8 schematically shows hardware structure of an electronic equipment for executing a crawler method according to the embodiments.

### DETAILED DESCRIPTION

The disclosure is described in further detail with reference to the drawings and embodiments below. Although the drawings show exemplary embodiments of the disclosure, it should be understood that the disclosure may be implemented in various forms but should not be limit to the embodiments set forth herein. On the contrary, these embodiments are contribute to a more thorough understanding of the disclosure, and can completely convey the scope of the disclosure to those skilled in the art.

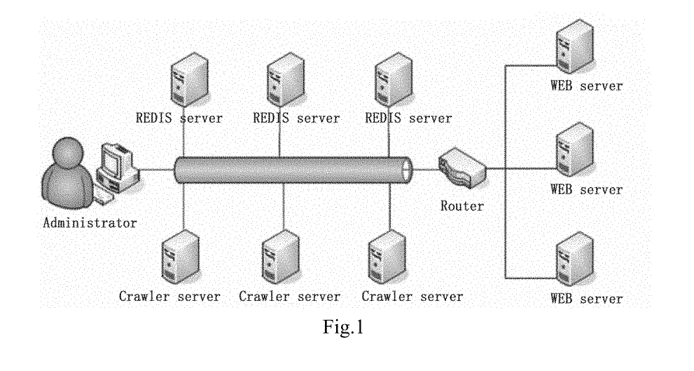

FIG. 1 is an arrangement diagram of a crawler system in accordance with an embodiment. As shown in FIG. 1, crawler servers, REDIS servers and WEB servers are coordinated to crawl web page data. The REDIS servers are servers installed with a REDIS data storage management system, which are adapted to store crawling tasks, and record information such as the crawled web page. The crawler servers are adapted to crawl web pages from the WEB server, store the web pages at the local, and then extract valid URL from the crawled web page and put the valid URL into a REDIS task queue. The WEB servers include web page servers supplied by various internet service suppliers, such as portal websites: Tencent, Sina, ifeng.com. The REDIS servers are only a storage model of storing the crawling task, the same effect can be achieved in additional storage manners for those skilled in the art. For example, MQ is used to store a message queue, or the crawling task is stored into an ORACLE database, however, the REDIS database has an advantage in data storage and retrieval with high concurrency.

The crawler system in accordance with the embodiment is arranged on the crawler server. According to the functional partition, the crawler system includes: a web page analyzer, a task module, and a crawler module. The web page analyzer is adapted to analyze a web page, acquire an IP address of the web page from a DNS server and generate a crawling task; the task module is adapted to store the crawling task into a task queue on the REDIS server; and the crawler module is adapted to acquire the crawling task from the task queue, and crawl web page data. In an optional embodiment, the web page analyzer and the crawler module operate in two different processes or threads respectively, and messages are transmitted through the task module. This is beneficial to avoid congestion in asynchronous operations.

According to the functional partition, the crawler module includes a first scheduling unit, a crawling unit, and a configuration unit. The first scheduling unit is adapted to acquire the crawling task from the task queue, and distribute the crawling task into multiple work queues; the crawling unit is adapted to acquire the crawling task from the work queues, and crawl the web page data from a WEB server based on the crawling task; and the configuration unit is adapted to configure environment variables for the first scheduling unit and the crawling unit according to a configuration file.

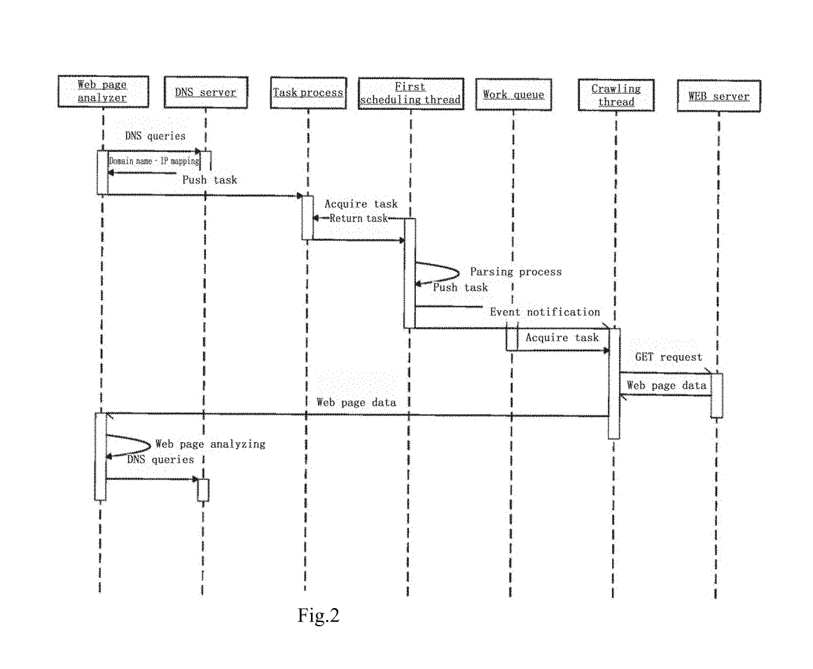

When the crawler module is started, firstly, the configuration unit is called to initial system resources, a thread pool for executing a first scheduling unit and a crawling unit is created, a work queue is applied for each crawling thread. Interactions among the first scheduling thread, a crawling thread, a web page analyzer, a DNS server and a WEB server are shown in FIG. 2.

In FIG. 2, firstly the web page analyzer analyzes web page data to generate a crawling task, and the crawling task is stored into a REDIS queue through a task process of the task module. The first scheduling thread acquires a task from the REDIS queue, and distributes the task into a work queue corresponding to the crawling thread. The crawling thread periodically reads the task from the corresponding work queue, acquires web page data from the WEB server, extracts information such as URL addresses, IP addresses, ports and abstract from the web page data to generate an index file for the web page data, and the web page data is stored into a magnetic disk. The web page analyzer sequentially analyzes the crawled local web page data to acquire related URL addresses which are not crawled in the web page and generate a new crawling task, and the crawling task is stored into the task queue on the REDIS server.

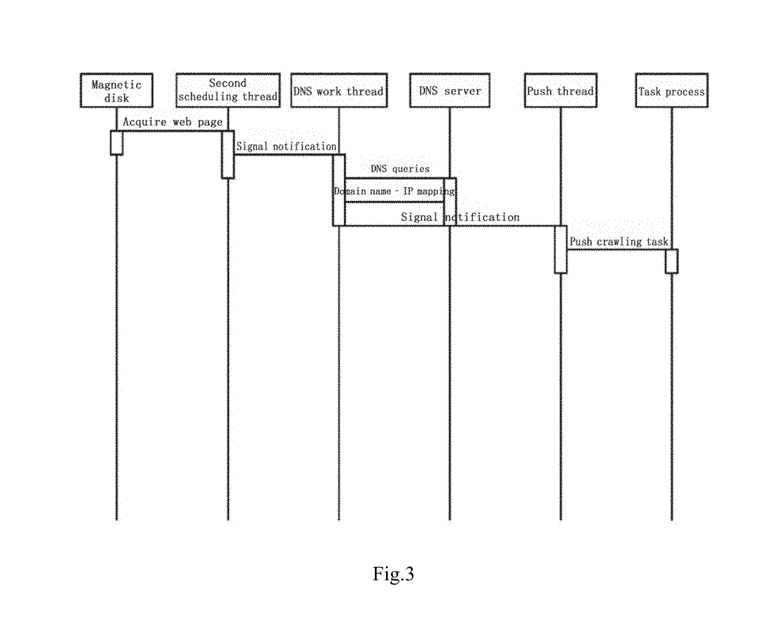

FIG. 3 is a timing diagram of a web page analyzer in accordance with an embodiment.

The web page analyzer includes: a second scheduling module, a DNS work module, and a push module. The second scheduling module is adapted to acquire the web page data, and extract the URL of the web page from the web page data. The DNS work module is adapted to acquire the IP address from the DNS server based on the URL of the web page, and generate the crawling task. The push module is adapted to push the crawling task into the task module. As shown in FIG. 3, a second scheduling thread executes the function of the second scheduling module, a DNS work thread executes the function of the DNS work module, and a push thread executes the function of the push module.

The second scheduling module firstly reads the web page data from the local magnetic disk, and submits the URL addresses which are not crawled to a DNS work thread. The DNS work thread queries and acquires mappings between the URL addresses and the IP addresses from the DNS server, and sends the mappings to a push thread. The push thread pushes the generated crawling task to a task process of the task module. In an optional embodiment, the DNS work thread caches the mappings between the URL addresses and the IP addresses into the local database to avoid repeatedly queries the queried URL addresses. In addition, the DNS work thread also stores a blacklist of URL addresses at the local, and stores illegal URL addresses. Thus, the DNS work thread may validate the URL addresses through the local caches and the blacklist of URL addresses before querying the URL addresses each time, thereby improving the efficiency of querying the URL addresses.

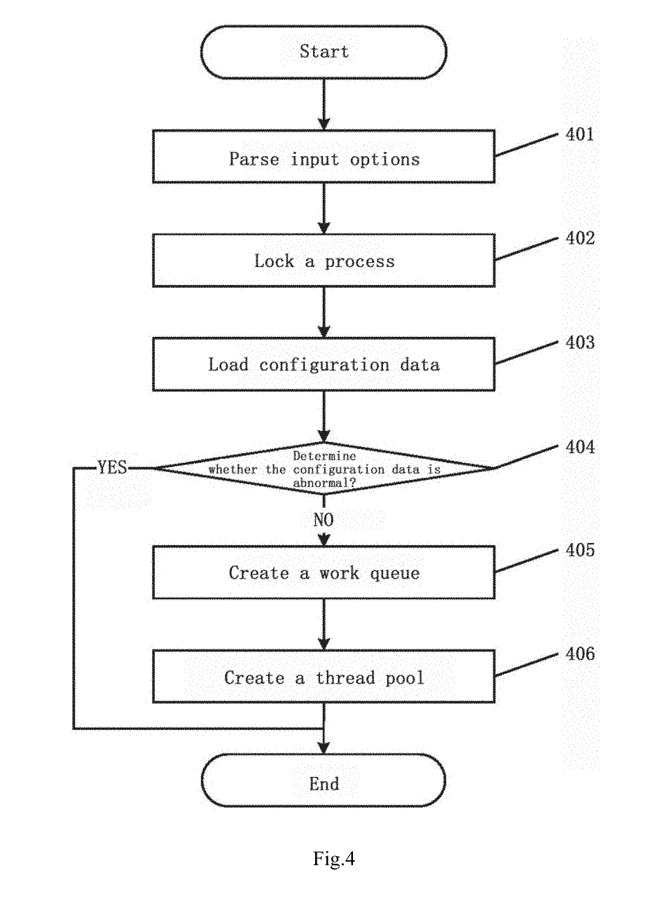

FIG. 4 is a flow chart of a configuration unit of a crawler module in accordance with an embodiment. As shown in FIG. 4, the configuration unit includes steps 401 to 406.

In step 401, input options are parsed. The input options may specify a configuration file path, determine whether the configuration unit runs in the background, display help information and the like.

In step 402, a process is locked. Since multiple crawler processes may run simultaneously in one directory, issues such as chaotic inter-process communications and covering crawled web pages may appear. A file lock is added when the process is started, which can effectively prevent the above issues.

In step 403, configuration data is loaded. The specified configuration file is loaded based on the input options, in preparation for the subsequent initialization.

In step 404, it is determined whether the configuration data is abnormal. If the configuration data is abnormal, the program ends; if the configuration data is normal, step 405 is performed.

In step 405, a work queue is created. The work queue is used to store information to be crawled by the crawler, such as URL of a web page, IP of a server, ports.

In step 406, a thread pool is created. A crawler thread pool and a scheduling thread pool exist in the crawler process. A crawler thread is adapted to crawl a web page from the WEB server, and a scheduling thread is adapted to distribute tasks in the REDIS queue into a work queue.

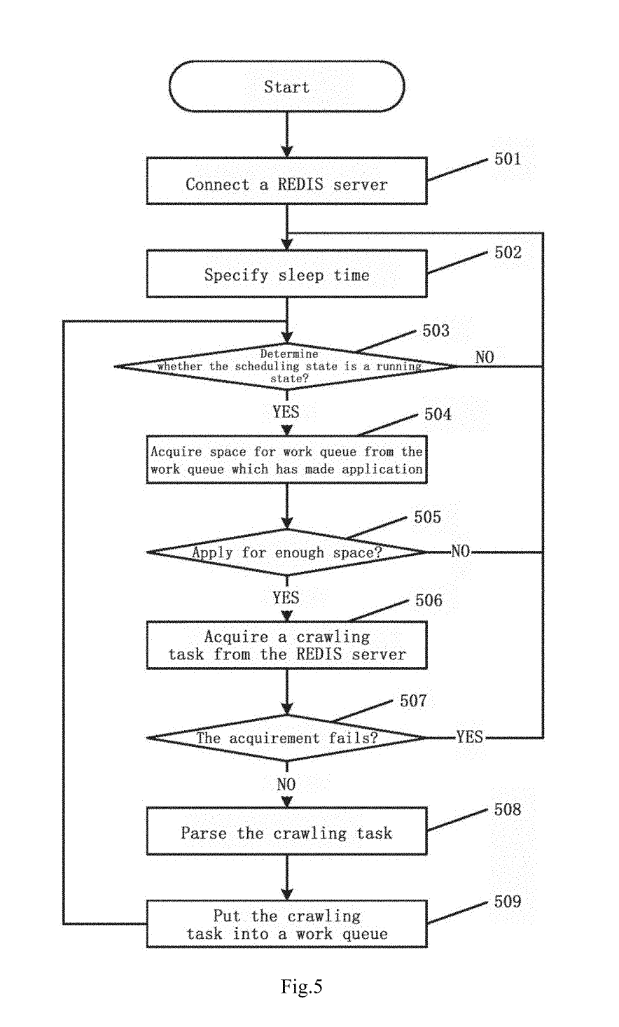

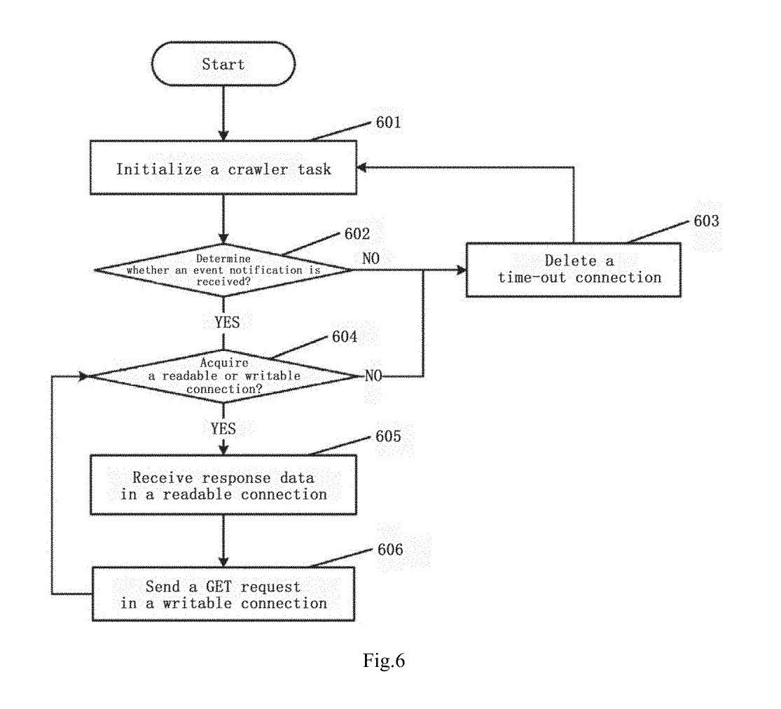

FIG. 5 is a flow chart of a first scheduling unit of a crawler module in accordance with an embodiment. As shown in FIG. 5, the first scheduling unit includes steps 501 to 509.

In step 501, a REDIS server is connected. The first scheduling thread is needed to acquire a crawling task from the REDIS server, thus a connection context for the REDIS server is needed to be created. Noted that: the connection for the REDIS server is not thread-safe, therefore, either the connection is used by only a single thread, or an exclusive lock is used in using the connection.

In step 502, sleep time is specified.

In step 503, it is determined whether the scheduling state is a running state. The scheduling state includes two states, that is, the running state and a pause state. If the scheduling state is the running state, crawling tasks are allowed to be acquired from REDIS server; if the scheduling state is the pause state, crawling tasks are not allowed to be acquired from REDIS server. The number of web pages crawled by the crawler is controlled by controlling the scheduling state.

In step 504, space for work queue is acquired from the work queue which has made application. The crawling task is eventually needed to be putted into the work queue. In order to prevent the problem that the insufficient space for work queue is found after the crawling tasks are acquired from the REDIS queue, firstly the space for work queue is applied for the crawling thread in circulation. In this case, the application of the queue space may reduce the number of times of copying data in the subsequent “parsing the crawling task”.

In step 505, sufficient space is applied. It is determined whether sufficient space for work queue can be applied. If the sufficient space for work queue can be applied, step 506 is performed; otherwise, step 502 is performed.

In step 506, a crawling task is acquired from the REDIS server. Data of the specified REDIS queue may be acquired based on the REDIS context and an LPOP command.

In step 507, it is determined whether the acquirement is successful, and if the acquirement is successful, step 508 is performed; otherwise, step 502 is performed.

In step 508, the crawling task is parsed. Valid data of an XML format in the crawling task is parsed and extracted.

In step 509, the crawling task is putted into a work queue. The acquired tasks are distributed into different work queues.

FIG. 6 is a flow chart of a crawling unit of a crawler module in accordance with an embodiment, which includes steps 601 to 606.

In step 601, a crawler task is initialized. The initialized task includes processes such as acquiring the crawling task and allocating resources for the task. Here, whether the crawling task is needed to be acquired does not managed with an event notification mechanism, but it is determined whether the crawling task is needed to be acquired in each circle. The processes such as connecting the WEB server, assembling a GET request, setting an event notification (write), registering an event callback and related resource allocation are included in this process.

In step 602, it is determined whether an event notification is received. If a readable or writable event notification is received, step 604 is performed; otherwise, step 603 is performed.

In step 603, a time-out connection is deleted. Since many WEB servers each are in different states, after the GET request is sent, each of the WEB servers has response time of different length, even no response message is generated. In order to avoid that the WEB server does not response for a long term and occupies system resources for a long term, the time-out unresponsive connection may be forced off.

In step 604, a readable or writable connection is acquired. If the readable or writable event notification is received in step 602, the connection, in which the above-mentioned event notification occurs, is acquired in this step.

In step 605, response data is received in a readable connection. The GET response data returned by WEB-SVR is received, and finally the response data is synchronized to a magnetic disk. In this process, performance is improved with a caching mechanism, and the network connection is closed after the data is received completely.

In step 606, a GET request is sent in a writable connection. The GET request in a sending list is sent to the WEB server. If the GET request is sent, a response read event is set.

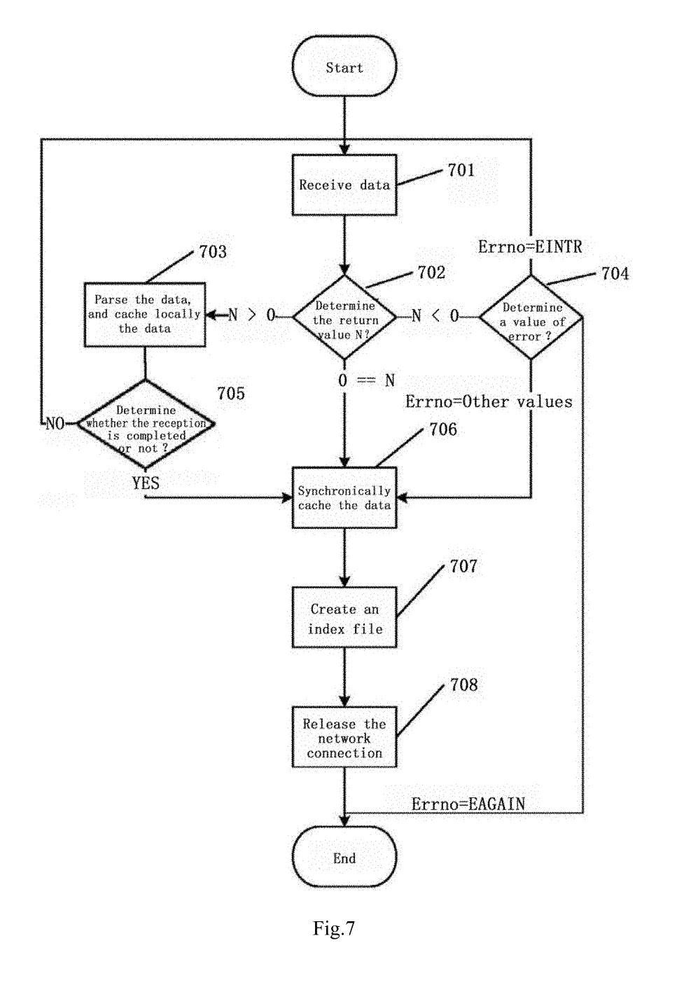

FIG. 7 is a flow chart of receiving data in a crawling unit of a crawler module in accordance with an embodiment, which includes steps 701 to 708.

In step 701, data is received. Response data is received with a read operation, and it is most important to determine and process its return value N.

In step 702, the return value N is determined.

In step 703, the data is parsed, and the data is cached locally. If the return value N is greater than 0, it indicates that data of a length n is received. The subsequent processing includes extracting header information of HTTP. If the length of the cached data is longer than a caching threshold, a synchronous operation is performed. If the actual length of the received data is equal to the length in the HTTP header, it indicates that the data is received completely, and the data is needed to be cached.

In step 704, a value of error codes error is determined. If the return value N is less than 0, error is equal to EINTR in this step, it indicates that a read operation is interrupted, a read operation is needed to be called, and step 701 is performed. If error is equal to EAGAIN, it indicates that all data is received completely, a next event notification is waited to continue to receive data, the program ends. If error is equal to another value other than EINTR and EAGAIN, it indicates that an abnormal case occurs, and step 706 is performed.

In step 705, it is determined whether the reception is completed or not. If the reception is completed, step 706 is performed; otherwise, step 701 is performed.

In step 706, the data is synchronically cached.

In step 707, an index file is created.

In step 708, the network connection is released.

In steps 706-708, if the return value N is equal to 0, it indicates that the server is actively disconnected from the network, the cached data is synchronized to a magnetic disk, and related resources are released.

A crawler system is provided according to the embodiment of the disclosure, which includes: a web page analyzer, adapted to analyze a web page, acquire an IP address of the web page from a DNS server and generate a crawling task; a task module, adapted to store the crawling task into a task queue; and a crawler module, adapted to acquire the crawling task from the task queue, and crawl web page data. With the crawler system and crawler method according to the disclosure, DNS queries are performed in web page analyzing, channel congestion caused by the DNS queries in the crawling process is avoided, thereby improving the crawling efficiency.

An embodiment of the present disclosure provides a non-transitory computer-readable storage medium storing executable instructions, which can be executed by an electronic equipment to perform any methods for crawler method mentioned by embodiments of the present disclosure.

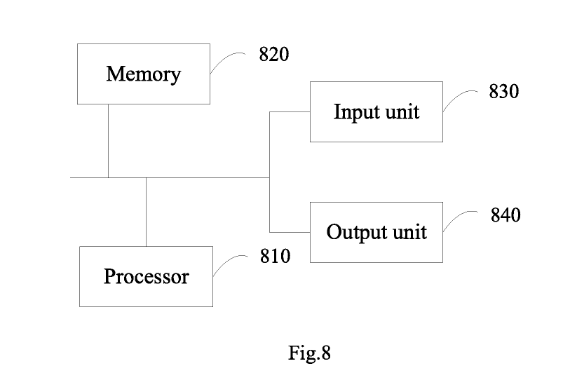

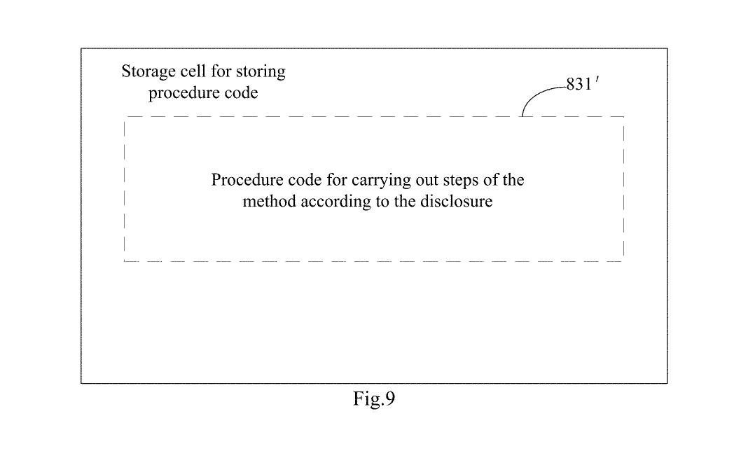

FIG. 8 schematically shows hardware structure of an electronic equipment for executing a crawler method. As shown in FIG. 8, the electronic equipment includes: one or more processors 810 and memory 820. A processor 810 is showed in FIG. 8 for an example.

The equipment which is configured to perform the crawler methods can also include: input unit 830 and output unit 840.

Processor 810, memory 820, input unit 830 and output unit 840 can be connected by BUS or other methods, and BUS connecting is showed in FIG. 8 for an example.

Memory 820 can be used for storing non-transitory software program, non-transitory computer executable program and modules as a non-transitory computer-readable storage medium, such as corresponding program instructions/modules for performing the crawler methods mentioned by embodiments of the present disclosure. Processor 810 performs kinds of functions and data processing of server by executing non-transitory software program, instructions and modules which are stored in memory 820, thereby realizes the crawler methods mentioned by embodiments of the present disclosure.

Memory 820 can include program storage area and data storage area, thereby the operating system and applications required by at least one function can be stored in program storage area and data created by using the equipment for the crawler system can be stored in data storage area. Furthermore, memory 820 can include high speed Random-access memory (RAM) or non-volatile memory such as magnetic disk storage device, flash memory device or other non-volatile solid state storage devices. In some embodiments, memory 820 can include long-distance setup memories relative to processor 810, which can communicate with the crawler system by networks. The examples of said networks are including but not limited to Internet, Intranet, LAN, mobile Internet and their combinations.

Input unit 830 can be used to receive inputted digital, character information and key signals causing user configures and function controls of the equipment for the crawler method. Output unit 840 can include a display screen or a display device.

The said module or modules are stored in memory 820 and perform the crawler methods mentioned by any of the embodiments when executed by one or more processors 810.

The said equipment can reach the corresponding advantages by including the function modules or performing the methods provided by embodiments of the present disclosure. Those methods can be referenced for technical details which may not be completely described in this embodiment.

The electronic equipment in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-14. (canceled)

15. A crawler method, applying to terminal, comprising:
a web page analyzing step of analyzing a web page, acquiring an IP address of the web page from a DNS server, generating a crawling task, and storing the crawling task into a task queue; and
a crawling step of acquiring the crawling task from the task queue, and crawling web page data.

16. The crawler method according to claim 15, wherein the web page analyzing step and the crawling step are executed in different processes or threads.

17. The crawler method according to claim 15, further comprising: locally caching a mapping between a URL address and the IP addresses of the web page, and saving illegal domain names into a blacklist.

18. The crawler method according to claim 15, wherein the task queue and work queues are stored into a REDIS database.

19. The crawler method according to claim 15, wherein a plurality of threads are started to crawl the web page data in the crawling step.

20. The crawler method according to claim 15, wherein the crawling task comprises an IP address, a URL address, and a crawling depth.

21. An electronic equipment, including:
at least one processor, and
a storage which is communicated by at least one processor.
Wherein, the storage stores executable instruction by one processor. The instruction is executed by the at least one processor, and enable the at least one processor to perform:
a web page analyzing step, analyzing a web page, acquiring an IP address of the web page from a DNS server, generating a crawling task, and storing the crawling task into a task queue; and
a crawling step, acquiring the crawling task from the task queue, and crawling web page data.

22. The electronic equipment according to claim 21, wherein the web page analyzing step and the crawling step are executed in different processes or threads.

23. The electronic equipment according to claim 21, the at least one processor performs: locally caching a mapping between a URL address and the IP addresses of the web page, and saving illegal domain names into a blacklist.

24. The electronic equipment according to claim 21, wherein the task queue and work queues are stored into a REDIS database.

25. The electronic equipment according to claim 21, wherein a plurality of threads are started to crawl the web page data in the crawling step.

26. The electronic equipment according to claim 21, wherein the crawling task comprises an IP address, a URL address, and a crawling depth.

27. A non-transitory computer storage medium, which stores computer executable instruction. The computer executable instruction is set for:
a web page analyzing step, analyzing a web page, acquiring an IP address of the web page from a DNS server, generating a crawling task, and storing the crawling task into a task queue; and
a crawling step, acquiring the crawling task from the task queue, and crawling web page data.

28. The non-transitory computer storage medium according to claim 27, wherein the web page analyzing step and the crawling step are executed in different processes or threads.

29. The non-transitory computer storage medium according to claim 27, the at least one processor performs: locally caching a mapping between a URL address and the IP addresses of the web page, and saving illegal domain names into a blacklist.

30. The non-transitory computer storage medium according to claim 27, wherein the task queue and work queues are stored into a REDIS database.

31. The non-transitory computer storage medium according to claim 27, wherein a plurality of threads are started to crawl the web page data in the crawling step.

32. The non-transitory computer storage medium according to claim 27, wherein the crawling task comprises an IP address, a URL address, and a crawling depth.
